(19) United States
(12) Patent Application Publication
(10) Pub. No.: US 2006/0080649 A1
(43) Pub. Date: Apr. 13, 2006

(54) Object initializing for updating a system state

(75) Inventor: Guy Eden, Tustin, CA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/960,543

(22) Filed: Oct. 7, 2004

(51) Int. Cl. G06F 9/44

(52) U.S. Cl. 717/168

(57) ABSTRACT

An initialization application system and method are provided. The method comprises: reviving a program application with uninitialized data objects; accessing an initialization application data, including object identification (OID), for creating object data; assembling the data into a tree structure; reading the OID from a node in the initialization application assembled tree structure; in response to reading the OID, creating an object with a position parameter; passing the node location to the object position; populating the object location with a value; and in response to populating the object location with a value, initializing a program application. The method may generate a volatile value for the object, and populate an object first location with the volatile value. The program application can be for a multifunctional peripheral (MFP) application. Then, volatile values may be generated for objects such as a domain name system (DNS) server addresses, IP addresses, or profile destinations.

### BACKGROUND OF THE INVENTION

1. Field of the Invention

This invention generally relates to program application microprocessor instructions and, more particularly, to a method for initializing or refreshing a program application that includes instructions with interdependent volatile data.

2. Description of the Related Art

Conventional software programs must have an initialization function that takes care of all initialization aspects of the program. If the program data items have fixed values, initialization is relatively straightforward. If the function operates on all volatile pieces of datum that need to be updated, it must first compute their values to obtain current states. An initialization procedure also needs to be responsive to any new data items that are introduced into the system. Therefore, when a new data item is added, the function needs to be revisited, recoded, and naturally recompiled. Recoding can be a significant problem if there is a dependency between volatile data items requiring that the data items be calculated in a specific order.

Conventional solutions depend on a hierarchy of objects, having pointers to contained objects, which in turn have pointers to more contained objects. Thus, in conventional systems, all object need to be created in order to revive all values.

It would be advantageous if an initialization application for a software program could be easily configured with interdependent volatile data values.

### SUMMARY OF THE INVENTION

This application describes a method for updating the state of the system. A system, or program application can have many pieces of data. Some of them can be persisted, with a fixed value, because they are immutable. For example, persisted data can be a profile name or copier model number. But some pieces of data are volatile, in that their state should not be saved. That is, the volatile data states need to be updated from time-to-time. For example, a network-connected device may need to update its Internet protocol (IP) address in a dynamic host configuration protocol (DHCP) environment.

Accordingly, an initialization application method is provided. The method comprises: reviving a program application with uninitialized data objects; accessing an initialization application data, including object identification (OID), for creating object data; assembling the data into a tree structure; reading the OID from a node in the initialization application assembled tree structure; in response to reading the OID, creating an object with a position parameter; passing the node location to the object position; populating the object location with a value; and in response to populating the object location with a value, initializing a program application.

For example, the method may generate a volatile value for the object, and populate an object first location with the volatile value. The method may also read a persistent value, and insert the persistent value into an object second location. The program application built can be for a multifunctional peripheral (MFP) application controlling the functions of a network-connected MFP. Then, volatile values may be generated for objects such as a domain name system (DNS) server addresses, IP addresses, or profile destinations.

In another aspect, the method reads a priority associated with sibling nodes embedded in the data node, and accesses sibling nodes in a BFS fashion. That is, higher priority sibling nodes are accessed prior to lower priority sibling nodes. In a different aspect, the tree structure of data nodes is a component object model (COM) software architecture, and the OID embedded in the data nodes is a global unique identifier (GUID) used to create the object in a late bind fashion.

Additional details of the above-described method and a system for initializing an MFP program application are provided below.

### BRIEF DESCRIPTION OF THE DRAWINGS

FIG. 1 is a schematic block diagram of a system for initializing an MFP program application.

FIG. 2 is a diagram illustrating an exemplary program application, built as a result of the initialization program.

FIG. 3 is a diagram illustrating an exemplary initialization application, such as might be used to build the program application of FIG. 2.

FIG. 4 is a diagram illustrating an exemplary initialization application with OID.

FIG. 5 is a diagram illustrating an exemplary tree structure.

FIGS. 6A and 6B are flowcharts illustrating variations in a method for updating the state of a system by initializing objects.

FIG. 7 depicts another exemplary initialization application.

FIG. 8 is yet another exemplary variation of the initialization application.

FIG. 9 is a flowchart illustrating a method for initializing a system of data objects in a signal-bearing medium tangibly embodying a program of machine-readable instructions executed by a digital device.

FIG. 10 is a flowchart illustrating a variation in the method for initializing a system of data objects in a signal-bearing medium tangibly embodying a program of machine-readable instructions executed by a digital device.

### DETAILED DESCRIPTION

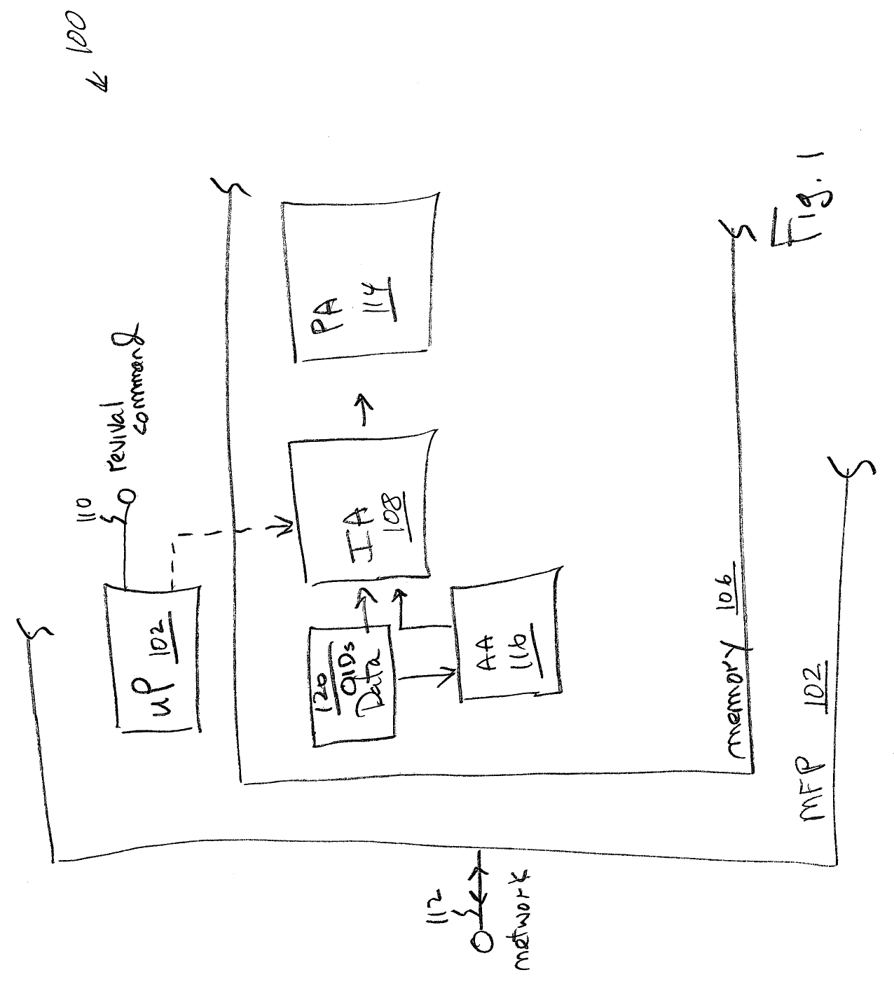

FIG. 1 is a schematic block diagram of a system for initializing an MFP program application. The system 100 resides in an MFP 102, and comprises a microprocessor (uP) 104 and a memory 106. It should be understood that the system 100 has relevance to a host of digital document processing devices, such a copiers, printers, facsimile machines, scanners, and devices that combine these functions. An initialization application (IA) 108 is shown residing in memory 106. The initialization application 108 includes data nodes assembled in a tree structure with objection identifications (OIDs) embedded in the data nodes. The data nodes, and thus the OIDs, are executed by the microprocessor 104 in response to a program revival command on line 110, for creating objects with object position parameters. For example, the program revival command may be given when the MFP 102 is turned on, or in response to a new device being added to network 112. The network 112 may be an intranet, local area network (LAN), or Internet for example. The MFP 102 may be connected, through network 112 to devices (not shown) such as network servers and personal computers for example.

A program application (PA) 114 of microprocessor executable instructions resides in memory 106 with data objects generated in response to populating the initialization application object positions with volatile values. An assembly application (AA) 116 may also reside in memory 106 for loading data, including OIDs, from memory in response to the program revival command on line 110. The assembly application assembles the data into a tree structure, and generates the initialization application. Alternately, the data 120 is stored in a tree structure so that no assembly is required.

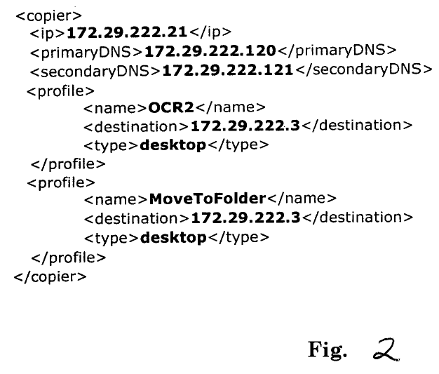

FIG. 2 is a diagram illustrating an exemplary program application, built as a result of the initialization program. The copier, DNS servers, and destinations all have IP addresses. These IP addresses may all be unknown (volatile data) when the copier is started. The initialization application determines values for volatile data items.

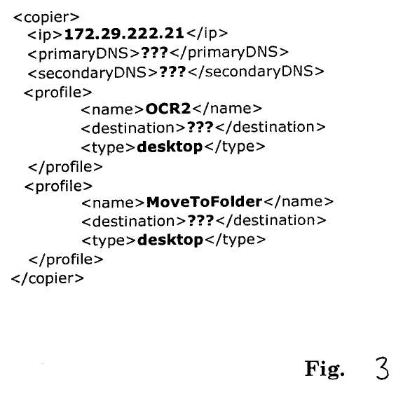

FIG. 3 is a diagram illustrating an exemplary initialization application, such as might be used to build the program application of FIG. 2. The initialization application traverses the nodes in a particular order, since a second volatile datum item may need to be computed after the calculations of a first volatile datum item. Thus, the nodes represent a location that is defined by the initialization application tree structure. The initialization application builds objects with position parameters. For example, the initialization application may populate an object first position with a volatile value. In FIG. 3 for example, the DNS server is volatile data located as a child node of the “copier” node. Thus, in FIG. 2, the DNS server object has a location defined as a child with respect to the “copier” node. The indentation shown is just style. Child nodes are always nested in parent nodes (parent begins, then child begins, then grandchild begins, then grandchild ends, child ends, second child begins, second child ends, parent ends).

The initialization application can also work with fixed value data. For example, in FIG. 3 the copier IP address may be a persistent value that is read from the data node, and the persistent value is inserted into an object second position, as a child of the “copier” node.

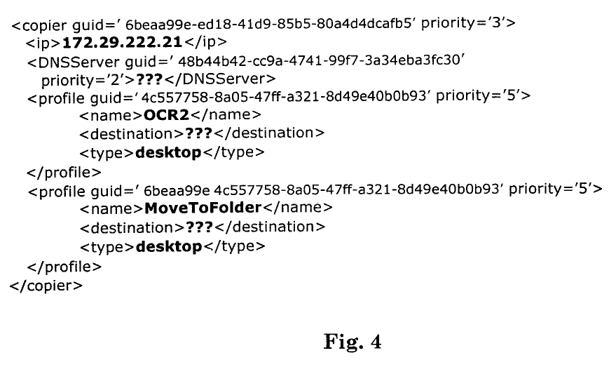

FIG. 4 is a diagram illustrating an exemplary initialization application with OID. The initialization application accesses a first node in a tree structure of data nodes, reads a first OID, creates a first object with a position parameter, and passes the first node location to the first object position. For example, the “DNS node” (beneath the copier IP) is read. That is, an OID is read, and the DNS server object is created as a result. Its location as a child node of the “copier” node is passed as an object position parameter (see FIG. 2). As shown, the initialization application is built in a component object model (COM) software architecture, with the OIDs being global unique identifiers (GUIDs). However, the method is not limited to this type of architecture. As shown, the initialization application populates volatile values for objects such as domain name system (DNS) server addresses, Internet Protocol (IP) addresses, and profile destinations. However, the volatile data objects are not limited to merely this list.

Alternately stated, the location of the node in the tree is predefined. But the location, or cue of how to generate the object from scratch, is identified by the GUID. There is a database with paths in the memory. The GUID constitutes the key, the query of which will retrieve the path. GUID is used to create the object, and pass the created object the location in the tree. That is, each node corresponds to an object annotated by a GUID (OID) value, so that it can be created. Each node has a priority tag, so that order of creation can be determined.

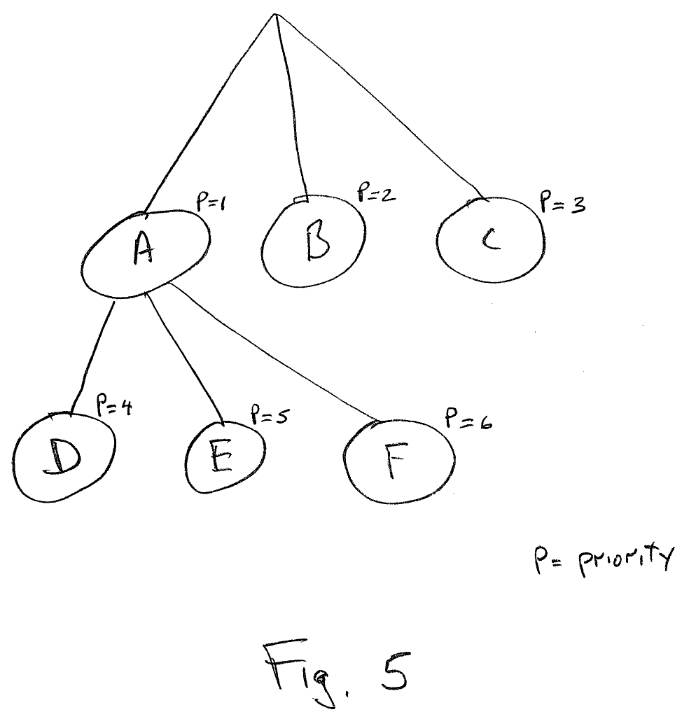

FIG. 5 is a diagram illustrating an exemplary tree structure. The initialization application passes tree structure node locations to object positions using a breadth first search (BFS) algorithm. More specifically, the initialization application reads priorities associated with sibling nodes embedded in the data node, and passes higher priority sibling nodes to object positions, prior to passing lower priority sibling nodes. In FIG. 5 sibling nodes A, B, and C, are processed prior to the child nodes D, E, and F, of node A. Thus, the order of processing is A, B, C, D, E, F. The order of processing is an alternate expression of the object position parameter, where nodes A-F are all objects. Retuning to FIG. 4, the priority of the DNS server object is expressed as a “2”. Thus, the calculation of this value takes priority over the “OCR2” profile, which is a sibling node with the priority of “5”.

The initialization application follows a path associated with the OID to a set of instructions in memory and, in response to executing the instructions, creates the object. At the end of the path, a program is found. Typically, the program is a dynamic link library (DLL), but it can also be EXE file, or any set of computer instructions that can be executed. The system runs the program, and gives it instructions or call functions such as initialize(param:TreePath), or ReviveData(param:DNSServer). A DLL is an executable program module in Microsoft Windows that is not launched by the user. Rather, they are called for by an executable program or by other DLLs. One DLL can be shared by many applications. In a UNIX operating system, a “shared library” performs a function equivalent to a DLL.

### Functional Description

As mentioned above, the state of the program/application is maintained in a tree structure, such as in extensible markup language (XML). Every object represents a node in the tree that may have sub-elements (child nodes) that comprise the data of the object. An object having sub-objects can be depicted as a node in the tree (e.g., copier node) having child nodes of IP address, DNS servers, and profile nodes, which in turn have sub-nodes of name, destination, and type (see FIG. 2).

As shown in FIG. 3, some states of the application are volatile, e.g., the copier's IP address, the DNS servers, and the profile's destination. When the system updates its state, a profile object obtains and updates the destination field, and the copier object updates its IP address and DNS servers. However, the remaining issues concerns which objects to instantiate (profile object), and how the copier object is instantiated in response to IP and DNS servers updates.

Thus, every node has a cue associated with the corresponding object, telling the system how to create the object. Each node in the tree also has a priority property that tells the system in what order to create the siblings. And so, one small and relatively simple recursive function can traverse the tree in a BFS fashion, create the objects, and give instructions to the objects for updating themselves. Adding a new object to the hierarchy does not entail changing the initialization function, as long as the new object corresponds to the tree conventions stated above. In fact, the initialization function need not be recompiled, as all the decisions are being made at runtime.

Consider an MFP. An MFP has a web page through which a user can change its state. The user can change the DNS servers that the MFP is using. The user runs an application that is using objects to represent MFPs. The application saves its state to the disk. The next time the user launches the application, the state is resurrected from disk. There are fields, however, that may have changed since the last time the program was run, referred to herein as volatile. For example, if the system administrator changes the DNS server addresses on the copier device, then the corresponding fields in the MFP object in the application are out of date, and need be updated. Thus, the initialization application is a scalable system in which objects get instantiated, in order to update the application's infoset.

In FIG. 3, the ‘destination’ node under the profiles, and the DNS names under the copier, are missing. Those “missing” nodes represent volatile data items. Since a profile's destination is volatile, (i.e. in a DHCP environment it may change, upon IP expiration lease) it needs to be re-computed periodically. By the same logic, the DNS servers used by the MFP are also volatile. The initialization application described herein computes those volatile values in a scalable manner. Furthermore, if there are parts of the data that need to be calculated before other parts, then the initialization system supports a priority or ordering.

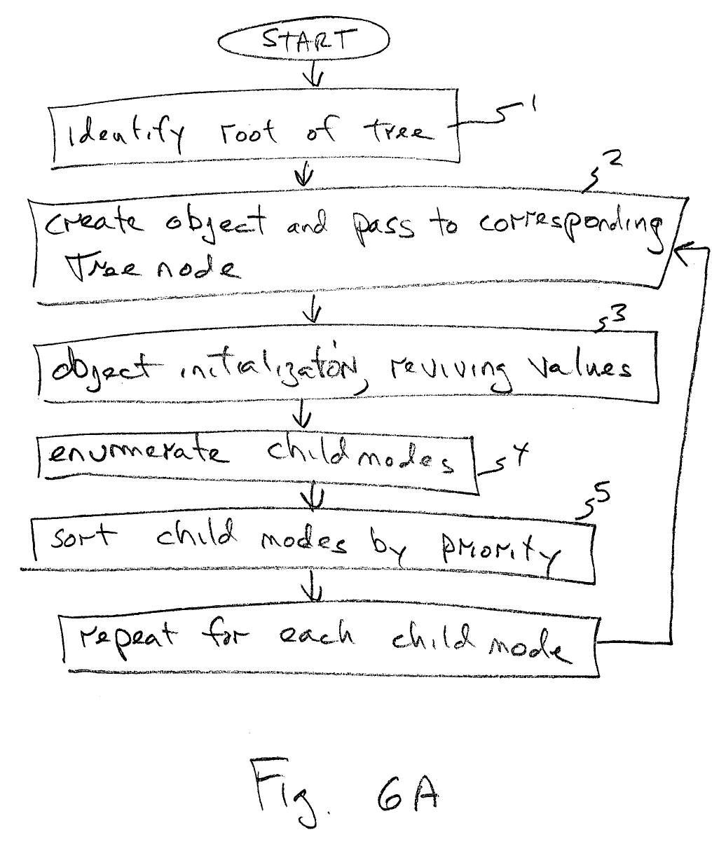

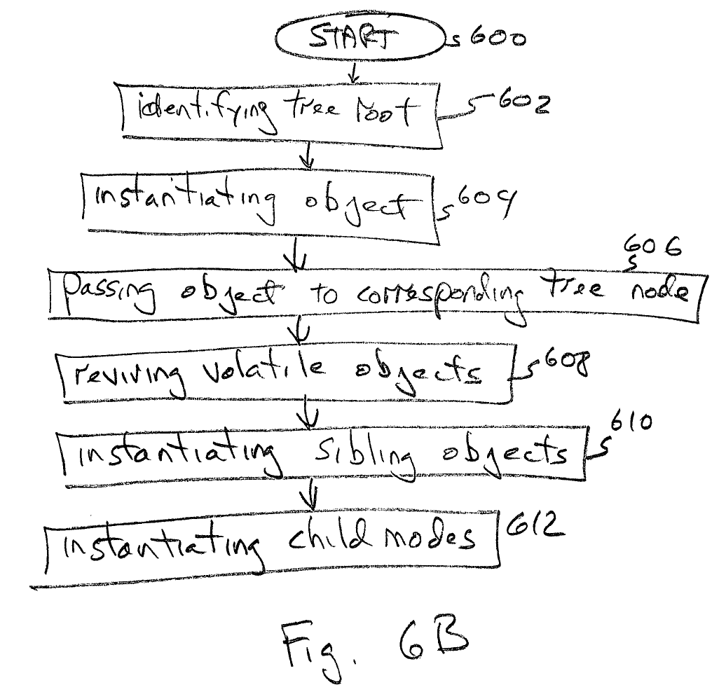

FIGS. 6A and 6B are flowcharts illustrating variations in a method for updating the state of a system by initializing objects. In FIG. 6A, the initialization application is a method for updating the state of a system by initializing objects, comprising the steps of:

1. Identifying the root of the tree, the root contains information on how to create the corresponding object (e.g., in COM a GUID would be a cue used by the system to create a specific object).

2. Creating the object and passing it to the corresponding node in the tree.

3. Each object does it's own initialization, reviving the missing values for which it's responsible.

4. Enumerating all child nodes and sorting by priority.

5. Recursively instantiating the child objects.

6. Passing child object corresponding child nodes.

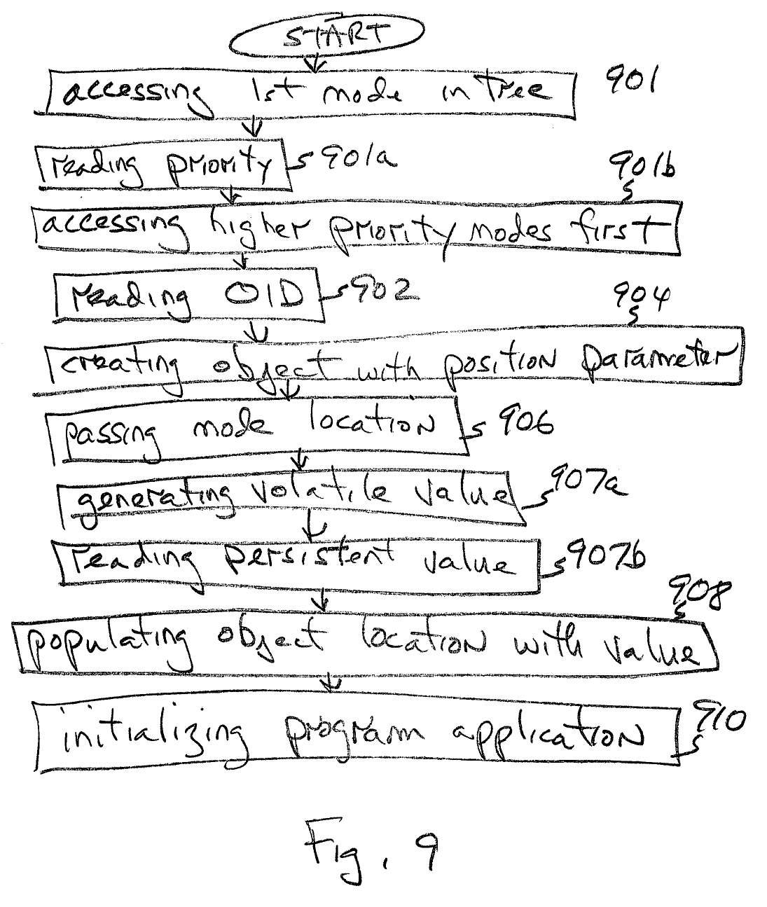

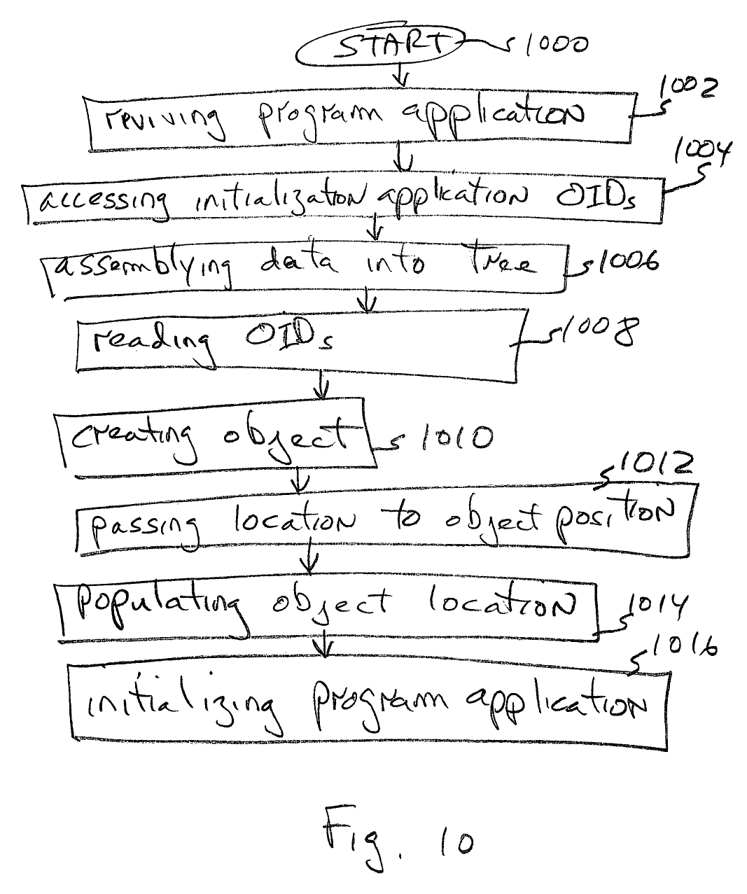

FIG. 6B is also a flowchart illustrating a method for updating the state of a system by initializing objects. Although the method (and the methods of FIGS. 9 and 10) is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 600.

Step 602 identifies the root of a tree, the root including cues for the creation of an object. Step 604 instantiates the object. Step 606 passes the object to a corresponding node in the tree. Step 608 revives volatile object values. Step 610 instantiates sibling objects by priority. Step 612 instantiates child nodes in a BFS manner.

Returning to FIG. 4, note that the DNS Server node has a priority of 2 (nodes with a lower priority value are traversed before sibling nodes with higher priority values), and the profile nodes have the priority of 5. This means that the DNS object will be created, the DNS value will be obtained, and then the profile object will be created. As the profile's destination value depends on the DNS value, profile values are computed after DNS values have been obtained. In this concrete example, the destination field under the profile node may contain an IP address (to where the destination job goes) in the format of: x.y.z.w, or as a fully qualified DNS name.

One advantage this system over conventional solutions is that not all the objects need to be instantiated at all times. Conventional solutions depend on a hierarchy of objects, having pointers to contained objects, which in turn have pointers to more contained objects. Thus, in conventional systems, all object need to be created in order to revive all values. In the present invention system, only objects that have the GUID value in the tree need to be instantiated. The system is able to create every element, without having to know how to create its parent element.

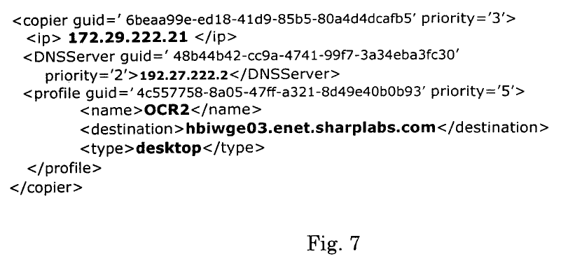

FIG. 7 depicts another exemplary initialization application. As mentioned above, the prioritized nodes enable value dependencies among initialized values. In this example the DNS server and the “OCR2” profile are sibling nodes. The DNS server's priority is set to “2”, the profile to “5”. After the DNS server value is revived, the profile object fills in it's values, and can read the value from the DNS server. As there is a DNS server, it's okay to populate the profile's destination with a fully qualified host name.

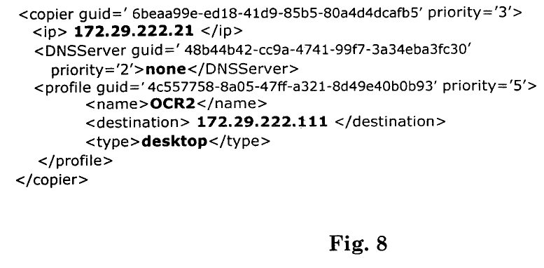

FIG. 8 is yet another exemplary variation of the initialization application. Again, the prioritized nodes enable value dependencies among initialized values. In this example, the DNS server's priority is set to “2”, and so its corresponding object obtained so that the copier does not have a corresponding DNS server. Then, the profile object fills in its values, and as there is no value in the DNS server, and the IP is supplied as the profile's destination.

FIG. 9 is a flowchart illustrating a method for initializing a system of data objects in a signal-bearing medium tangibly embodying a program of machine-readable instructions executed by a digital device. The method starts at Step 900.

Step 901 (prior to Step 902) accesses a first node in a tree structure of data nodes. Step 902 reads an OID embedded in data at a node location. Step 904 creates an object with a position parameter in response to reading the OID. Step 906 passes the node location to the object position. Referencing Step 901, Step 906 passes the tree first node location to the object position. Step 908 populates the object location with a value. Step 910 initializes a program application in response to populating the object location with a value.

In one aspect, Step 907a generates a volatile value for the object. Then, populating the object location with a value in Step 908 includes populating an object first location with the volatile value. In a different aspect, Step 907b reads a persistent value. Then, Step 908 inserts the persistent value into an object second location.

In some aspects, accessing the first node in the tree structure of data nodes (Step 901) includes accessing sibling and sibling's children nodes in a BFS fashion. That is, Step 901a reads a priority associated with sibling nodes embedded in the data node. Then, Step 901b accesses higher priority sibling nodes prior to accessing lower priority sibling nodes.

In other aspects, creating the object in response to reading the OID in Step 904 includes substeps (not shown). Step 904a follows a path associated with the OID. Step 904b executes a set of object creation instructions in response to following the path.

In one variation of the method, accessing the first node in the tree structure of data nodes (Step 901) includes accessing the first node in a component object model (COM) software architecture. Then, reading the OID embedded in the data node (Step 902) includes reading a global unique identifier (GUID).

In one example, initializing the program application in Step 910 includes building a MFP application controlling the functions of a network-connected MFP. Thus, generating the volatile value for the object in Step 907a includes generating a volatile value for objects such as a DNS server address, IP address, or profile destination.

FIG. 10 is a flowchart illustrating a variation in the method for initializing a system of data objects in a signal-bearing medium tangibly embodying a program of machine-readable instructions executed by a digital device. The method starts at Step 1000. Step 1002 revives a program application with volatile data objects. Typically, the volatile data objects are unintialized, or they need to be refreshed. Step 1004 accesses initialization application data, including OID, for creating object data. Step 1006 assembles the data into a tree structure. Step 1008 reads the OID embedded in a data nodes of the assembled tree structure. That is, the data is read from a node in the initialization application assembled tree structure. Step 1010 creates an object with a position parameter. Step 1012 passes the data node location to the object position. Step 1014 populates the object location with a volatile value. Step 1016, in response to populating the object location with a value, initializes the program application with revived volatile values.

A system and method have been presented for initializing a system of data objects. Examples of the invention have been given within the context of a network-connected printer. However, the invention is not limited to use in any particular type of device, interface, or device function. Likewise, examples have been given of the invention in the context of a Microsoft Windows operating system. Again, the invention is not limited to any particular operating system. Other variations and embodiments of the invention will occur to those skilled in the art.

We claim:

1. In a signal-bearing medium tangibly embodying a program of machine-readable instructions executed by a digital device, a method for initializing a system of data objects, the method comprising:
reading an object identification (OID) embedded in data at a node location;
in response to reading the OID, creating an object with a position parameter;
passing the node location to the object position;
populating the object location with a value; and
in response to populating the object location with a value, initializing a program application.

2. The method of claim 1 further comprising:
generating a volatile value for the object; and
wherein populating the object location with a value includes populating an object first location with the volatile value.

3. The method of claim 2 further comprising:
reading a persistent value; and
wherein populating the object location with a value includes inserting the persistent value into an object second location.

4. The method of claim 2 further comprising:
prior to reading the OID, accessing a first node in a tree structure of data nodes; and,
wherein passing the node location to the object position includes passing the tree first node location to the object position.

5. The method of claim 4 wherein accessing the first node in the tree structure of data nodes includes accessing sibling and sibling's children nodes in a breadth first search (BFS) fashion.

6. The method of claim 5 wherein accessing sibling and sibling's children nodes in a breadth first search (BFS) fashion includes:
reading a priority associated with sibling nodes embedded in the data node; and
accessing higher priority sibling nodes prior to accessing lower priority sibling nodes.

7. The method of claim 1 wherein creating the object in response to reading the OID includes:
following a path associated with the OID; and
in response to following the path, executing a set of object creation instructions.

8. The method of claim 4 wherein accessing the first node in the tree structure of data nodes includes accessing the first node in a component object model (COM) software architecture; and
wherein reading the OID embedded in the data node includes reading a global unique identifier (GUID).

9. The method of claim 2 wherein initializing the program application includes building a multifunctional peripheral (MFP) application controlling the functions of a network-connected MFP; and
wherein generating the volatile value for the object includes generating a volatile value for objects selected from the group including domain name system (DNS) server addresses, Internet Protocol (IP) addresses, and profile destinations.

10. The method of claim 1 further comprising:
reviving a program application with uninitialized data objects;
accessing initialization application data, including OID, for creating object data;
assembling the data into a tree structure; and
wherein reading the OID embedded in a data node includes reading the data from a node in the initialization application assembled tree structure.

11. In a signal-bearing medium tangibly embodying a program of machine-readable instructions executed by a digital device, a method for initializing a system of data objects, the method comprising:
reviving a program application with volatile data objects;
accessing initialization application data, including object identification (OID), for creating object data;
assembling the data into a tree structure;
reading the OID embedded in a data nodes of the assembled tree structure;
creating an object with a position parameter;
passing the data node location to the object position;
populating the object location with a volatile value; and
in response to populating the object location with a value, initializing the program application with revived volatile values.

12. A system for initializing a multifunctional peripheral (MFP) program application, the system comprising:
a microprocessor and memory;
an initialization application of data nodes assembled in a tree structure with objection identifications (OIDs) embedded in the data nodes that are executed by the microprocessor in response to a program revival command, for creating objects with object position parameters; and
a program application of microprocessor executable instructions with data objects generated in response to populating the initialization application object positions with volatile values.

13. The system of claim 12 further comprising:
an assembly application for loading data, including OIDs, from memory in response to the program revival command, assembling the data into a tree structure, and generating the initialization application.

14. The system of claim 12 wherein the initialization application populates an object first position with a volatile value, and in response to reading a persistent value from the data node, inserts the persistent value into an object second position.

15. The system of claim 12 wherein the initialization application accesses a first node in a tree structure of data nodes, reads a first OID, creates a first object with a position parameter, and passes the first node location to the first object position.

16. The system of claim 12 wherein the initialization application passes tree structure node locations to object positions using a breadth first search (BFS) algorithm.

17. The system of claim 16 wherein the initialization application reads priorities associated with sibling nodes embedded in the data node, and passes higher priority sibling nodes to object positions prior to lower priority sibling nodes.

18. The system of claim 12 wherein the initialization application follows a path associated with the OID to a set of instructions in memory and, in response to executing the instructions, creates the object.

19. The system of claim 12 wherein the initialization application is built in a component object model (COM) software architecture, with the OIDs being global unique identifiers (GUIDs).

20. The system of claim 12 wherein the initialization application populates volatile values for objects selected from the group including domain name system (DNS) server addresses, Internet Protocol (IP) addresses, and profile destinations.

21. In a signal bearing medium tangibly embodying a program of machine-readable instructions executed by a digital device, a method for updating the state of a system by initializing objects, the method comprising:
identifying the root of a tree, the root including cues for the creation of an object;
instantiating the object;
passing the object to a corresponding node in the tree;
reviving volatile object values;
instantiating sibling objects by priority; and
instantiating child nodes in a breadth first search (BFS) manner.
